(19) United States
(12) Patent Application Publication
(10) Pub. No.: US 2021/0063660 A1
(43) Pub. Date: Mar. 4, 2021

(54) WAVEGUIDE TUBE HAVING A NANO PLATING LAYER AND WAVEGUIDE TUBE ASSEMBLY INCLUDING THE SAME

(71) Applicant: Cheng Uei Precision Industry Co., Ltd., New Taipei City (TW)

(72) Inventor: James Cheng Lee, La Habra, CA (US)

(21) Appl. No.: 16/906,279

(22) Filed: Jun. 19, 2020

(30) Foreign Application Priority Data
Sep. 2, 2019 (CN) 201921450783.8

(51) Int. Cl. G02B 6/42; G02B 6/293

(52) U.S. Cl. CPC G02B 6/4291; G02B 6/4277; G02B 6/29325; G02B 6/29307

(57) ABSTRACT

A waveguide tube includes a first waveguide block, a second waveguide block and a nano plating layer. The first waveguide block has a first combination surface. A middle of one side of the first combination surface is recessed inward to form a first waveguide recess. The second waveguide block is fastened with the first waveguide block. The second waveguide block has a second combination surface disposed corresponding to the first combination surface. A middle of one side of the second combination surface is recessed inward to form a second waveguide recess. The first combination surface and the second combination surface are attached with each other, so the first waveguide recess is combined with the second waveguide recess to form a waveguide space. The nano plating layer is plated on outer surfaces of the first waveguide block and the second waveguide block which are completed being assembled.

### CROSS-REFERENCE TO RELATED APPLICATION

The present application is based on, and claims priority from, China Patent Application No. 201921450783.8, filed Sep. 2, 2019, the disclosure of which is hereby incorporated by reference herein in its entirety.

### BACKGROUND OF THE INVENTION

### 1. Field of the Invention

The present invention generally relates to a waveguide tube having a nano plating layer, and a waveguide tube assembly including the same, and more particularly to a waveguide tube having a nano plating layer, and a waveguide tube assembly including the same which are capable of reducing signal losses and electromagnetic interferences.

### 2. The Related Art

Referring to FIG. 5, a conventional waveguide tube 1′ includes a first waveguide block 11′, a second waveguide block 12′ and a group of pads 17′. The first waveguide block 11′ and the second waveguide block 12′ have two recesses 18′ facing to each other, respectively. When the first waveguide block 11′ and the second waveguide block 12′ are assembled, the group of the pads 17′ are assembled to two facing assembling surfaces of the first waveguide block 11′ and the second waveguide block 12′, and the group of the pads 17′ and the two recesses 18′ of the group of the pads 17′ are staggered, at the moment, the two recesses 18′ and the group of the pads 17′ are mutually combined with each other to form a waveguide space. The waveguide space is used for conducting high-frequency electromagnetic waves. The first waveguide block 11′, the group of the pads 17′ and the second waveguide block 12′ are connected and fastened together by bolts, in this way, the conventional waveguide tube 1′ is assembled.

Referring to FIG. 6, the conventional waveguide tube 1′ is applied in a conventional waveguide tube assembly 100′. The conventional waveguide tube assembly 100′ has a hollow metal tube 14′ and at least one washer 15′. The metal tube 14′ includes at least two conventional waveguide tubes 1′, so the at least two conventional waveguide tubes 1′ are assembled to form the hollow metal tube 14′. A middle of the metal tube 14′ is a hollow part. The hollow part of the metal tube 14′ is a combined waveguide space 13′. The combined waveguide space 13′ is used for conducting the high-frequency electromagnetic waves. A connecting portion between each two conventional waveguide tubes 1′ is equipped with one washer 15′, and the at least two conventional waveguide tubes 1′ and the at least one washer 15′ are fastened together by the bolts, in this way, the conventional waveguide tube assembly 100′ are assembled.

However, the above-mentioned assembling way causes a connecting and fastening portion among the first waveguide block 11′, the second waveguide block 12′ and the group of pads 17′ of the conventional waveguide tube 1′, and a mutual connecting portion between each conventional waveguide tube 1′ and one pad 17′ will generate larger interstices, and the larger interstices will cause signal losses and an antenna effect of the conventional waveguide tube 1′ to be happened, and external electromagnetic waves easily enter the conventional waveguide tube 1′ or the conventional waveguide tube assembly 100′ through the interstices. Thus, transmission effects of the conventional waveguide tube 1′ and the conventional waveguide tube assembly 100′ are affected.

In view of the above-mentioned problems, an innovative waveguide tube and an innovative waveguide tube assembly are essential to be provided to solve the above-mentioned problems, the innovative waveguide tube and the innovative waveguide tube assembly are capable of reducing signal losses and avoiding suffering external electromagnetic interferences.

### SUMMARY OF THE INVENTION

An object of the present invention is to provide a waveguide tube. The waveguide tube includes a first waveguide block, a second waveguide block and a nano plating layer. The first waveguide block has a first combination surface. A middle of one side of the first combination surface is recessed inward to form a first waveguide recess penetrating through two end surfaces of the first waveguide block. The second waveguide block is fastened with the first waveguide block. The second waveguide block has a second combination surface disposed corresponding to the first combination surface. A middle of one side of the second combination surface is recessed inward and opposite to the first waveguide recess to form a second waveguide recess penetrating through two end surfaces of the second waveguide block. The second waveguide recess is disposed corresponding to the first waveguide recess. The first combination surface of the first waveguide block and the second combination surface of the second waveguide block are attached with each other, so the first waveguide recess is combined with the second waveguide recess to form a waveguide space between the first waveguide block and the second waveguide block. The nano plating layer is plated on outer surfaces of the first waveguide block and the second waveguide block which are completed being assembled and are plated by a nano-plating way. The nano plating layer fills up an interstice generated between the first waveguide block and the second waveguide block. The nano plating layer is formed by a nanometal material. The nano plating layer has nanoparticles.

Another object of the present invention is to provide a waveguide tube assembly. The waveguide tube assembly includes at least two waveguide tubes and a nano plating layer. Each waveguide tube is a hollow metal tube. A hollow portion of each waveguide tube is a waveguide space longitudinally penetrating through two opposite end surfaces of each waveguide tube. The waveguide space is used for transmitting high-frequency electromagnetic waves. The at least two waveguide tubes are longitudinally fastened with and connected with one another, so the waveguide spaces of the at least two waveguide tubes are connected with one another to form a combined waveguide space. The nano plating layer is plated on outer surfaces of the at least two waveguide tubes which are together connected and are plated by a nano-plating way, and the nano plating layer fills up each interstice formed among the at least two waveguide tubes. The nano plating layer is formed by a nanometal material. The nano plating layer has nanoparticles.

Another object of the present invention is to provide a waveguide tube assembly. The waveguide tube assembly includes at least two waveguide tubes of which each is a hollow metal tube and is shown as a hollow cylinder shape, and a nano plating layer. A middle portion of each waveguide tube has a waveguide space longitudinally penetrating through a front end surface and a rear end surface of each waveguide tube. The waveguide space is cylindrical. The at least two waveguide tubes are longitudinally fastened with and connected with one another by an ultrasonic welding way. The front end surface of one of each two adjacent waveguide tubes is connected with a rear end surface of the other one of the each two adjacent waveguide tubes which is located in front of the one of the each two adjacent waveguide tubes, so the waveguide spaces of the at least two waveguide tubes are connected with one another to form a combined waveguide space. The nano plating layer is plated on outer surfaces of the at least two waveguide tubes which are together connected and are plated by a nano-plating way, and the nano plating layer fills up interstices formed at connecting portions disposed among the at least two waveguide tubes to make the connecting portions disposed among the at least two waveguide tubes be seamless. The nano plating layer is formed by a nanometal material. The nano plating layer has nanoparticles.

As described above, because the first waveguide block is connected with the second waveguide block, the nano plating layer fills up the interstice generated between the first waveguide block and the second waveguide block of the waveguide tube by virtue of the nano plating layer being plated on the outer surface of the waveguide tube, and because the at least two waveguide tubes of the waveguide tube assembly are connected, the nano plating layer fills up each interstice formed at a position where a first connecting end and a second connecting end of the each two adjacent waveguide tubes of the waveguide tube assembly are connected by virtue of the nano plating layer being plated on the outer surface of the waveguide tube assembly, so that the waveguide tube and the waveguide tube assembly are effectively capable of filling up the interstice to reduce signal losses generated by the interstice and electromagnetic interferences. In addition, the waveguide tube and the waveguide tube assembly have multiple functions which include a waterproof function, an antioxidative function, a corrosion resistance function and a function of electromagnetic interference prevention.

### BRIEF DESCRIPTION OF THE DRAWINGS

The present invention will be apparent to those skilled in the art by reading the following description, with reference to the attached drawings, in which:

FIG. 1 is a perspective view of a waveguide tube in accordance with a first preferred embodiment of the present invention;

FIG. 2 is a sectional view of the waveguide tube along a line II-II of FIG. 1;

FIG. 3 is a perspective view of a waveguide tube assembly in accordance with a second preferred embodiment of the present invention, wherein the waveguide tube assembly includes at least two waveguide tubes;

FIG. 4 is a sectional view of the waveguide tube assembly along a line IV-IV of FIG. 3;

FIG. 5 is an exploded perspective view of a conventional waveguide tube in prior art; and

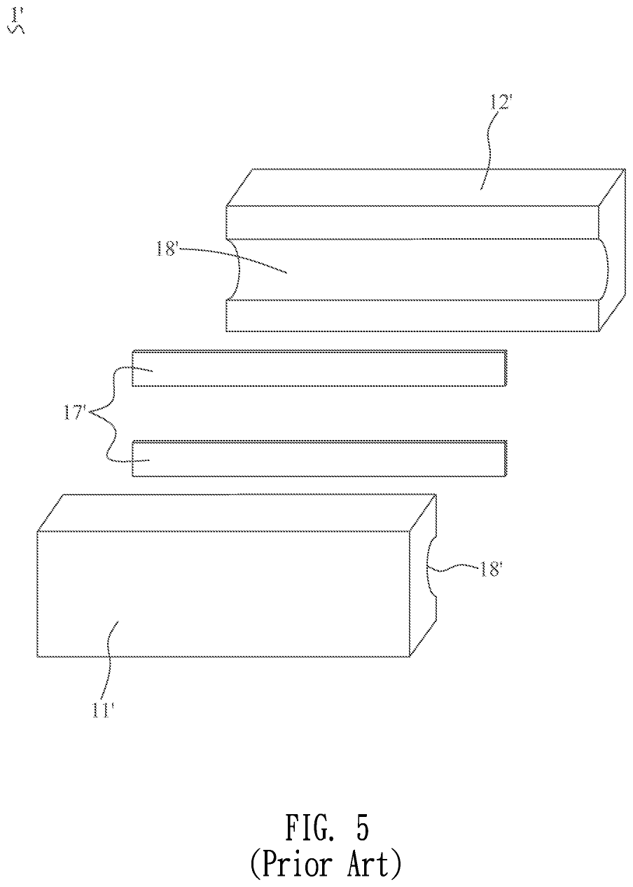

FIG. 6 is an exploded perspective view of a conventional waveguide tube assembly in the prior art.

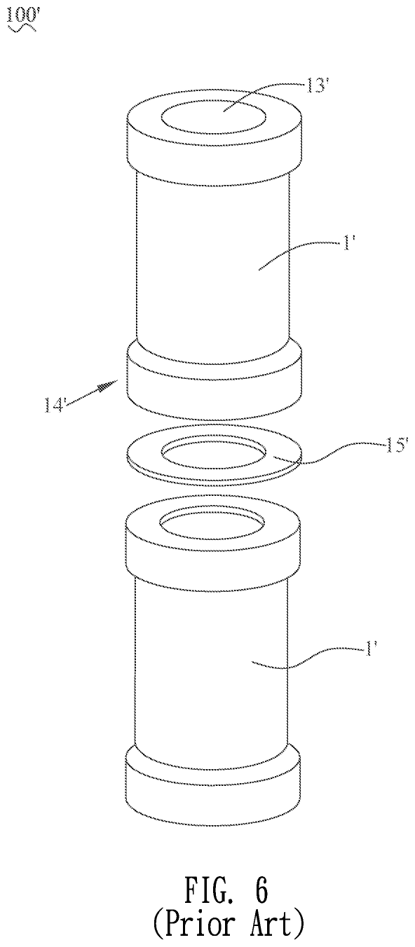

### DETAILED DESCRIPTION OF THE PREFERRED EMBODIMENT

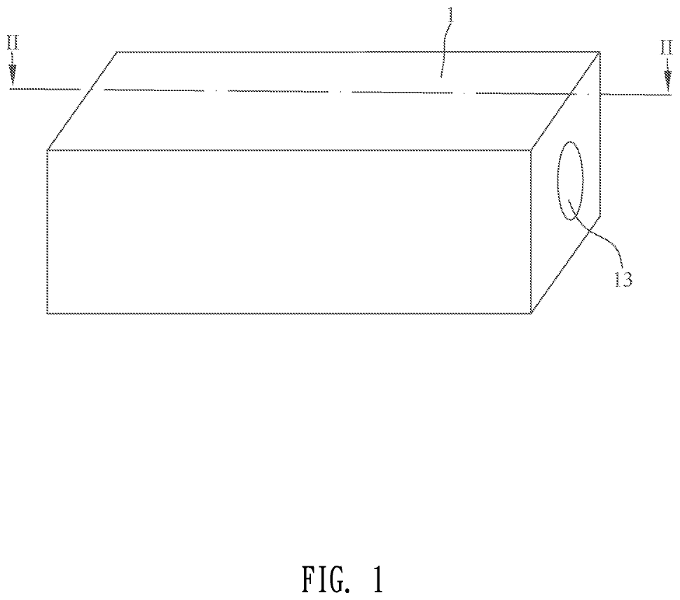

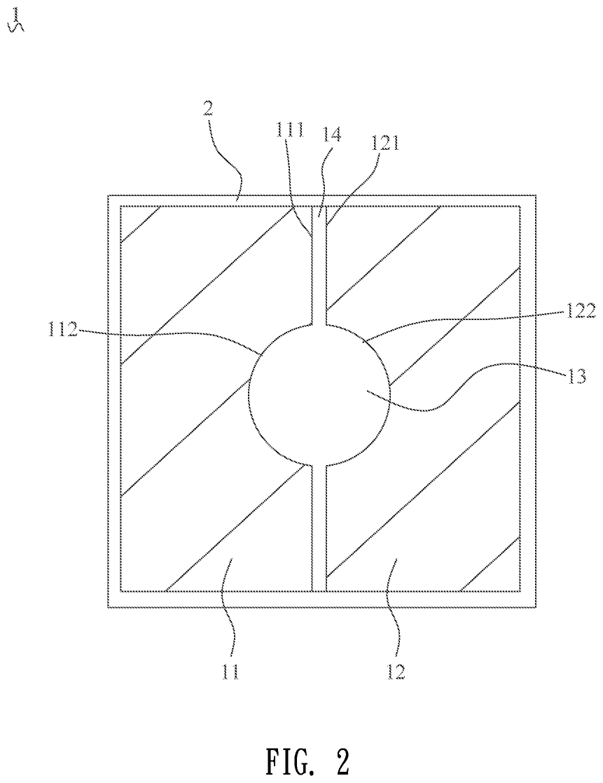

With reference to FIG. 1 to FIG. 4, a waveguide tube 1 and a waveguide tube assembly 100 in accordance with the present invention are shown. The waveguide tube 1 is applied to the waveguide tube assembly 100. The waveguide tube 1 in accordance with a first preferred embodiment of the present invention includes a first waveguide block 11, a second waveguide block 12 and a nano plating layer 2.

The first waveguide block 11 and the second waveguide block 12 are rectangular shapes. The first waveguide block 11 has a first combination surface 111. A middle of one side of the first combination surface 111 of the first waveguide block 11 is recessed inward to form a first waveguide recess 112 penetrating through two end surfaces of the first waveguide block 11. The second waveguide block 12 has a second combination surface 121. The second combination surface 121 is disposed corresponding to the first combination surface 111. A middle of one side of the second combination surface 121 of the second waveguide block 12 is recessed inward and opposite to the first waveguide recess 112 to form a second waveguide recess 122 penetrating through two end surfaces of the second waveguide block 12. The second waveguide recess 122 is disposed corresponding to the first waveguide recess 112.

The waveguide tube 1 is assembled, the second waveguide block 12 is transversely fastened with and connected with the first waveguide block 11. The first combination surface 111 of the first waveguide block 11 and the second combination surface 121 of the second waveguide block 12 are disposed face to face and are attached with each other. The first combination surface 111 and the second combination surface 121 are welded with each other by an ultrasonic welding way, so the first waveguide recess 112 is combined with the second waveguide recess 122 to form a waveguide space 13 between the first waveguide block 11 and the second waveguide block 12. The waveguide space 13 is cylindrical. The waveguide space 13 is used for transmitting high-frequency electromagnetic waves. A portion where the first combination surface 111 and the second combination surface 121 are attached with each other generates an interstice 14 between the first combination surface 111 and the second combination surface 121.

The nano plating layer 2 is plated on an outer surface of the waveguide tube 1. The nano plating layer 2 is plated on outer surfaces of the first waveguide block 11 and the second waveguide block 12 which are completed being assembled and are plated by a nano-plating way. An ingredient of the nano plating layer 2 is a nanometer electroplating solution. The nano plating layer 2 fills up the interstice 14 generated between the first waveguide block 11 and the second waveguide block 12.

In a nano-plating process of the waveguide tube 1, an electroplating liquid is prepared, and nanoparticles are added into the electroplating liquid to form a nano electroplating liquid. When the waveguide tube 1 is plated, the nanoparticles continuously rub against an outer surface of the nano plating layer 2 exposed outside, so that bubbles of the outer surface of the nano plating layer 2 are effectively eliminated and the nano plating layer 2 is mechanically grinded and polished for improving a finish degree and a comprehensive mechanism strength of the nano plating layer 2. The nano plating layer 2 is formed by a nanometal material. The ingredient of the nano plating layer 2 includes nickel mineral salts, such as a nickel sulfate and a nickel chloride, an inorganic acid, such as a boric acid, an interfacial agent, such as a lauryl sodium sulfate, nanoparticles and so on. Each nanoparticle is one of a silver nanoparticle, a titanium dioxide nanoparticle, a silicon dioxide nanoparticle, an alumina nanoparticle, a zinc oxide nanoparticle and others. The nano plating layer 2 has the nanoparticles. The nano plating layer 2 including the nanoparticles provides a waterproof function for the waveguide tube 1, an antioxidative function, a sulfuration corrosion resistance function and a function of electromagnetic interference prevention for the waveguide tube 1. The above-mentioned ingredient of the nano plating layer 2 is just provided by general ingredients and is without being limited to the ingredients which are disclosed above. In this way, the waveguide tube 1 is effectively capable of eliminating signal losses generated by the interstice 14 and electromagnetic interferences. In addition, the waveguide tube 1 has multiple functions which include the waterproof function, the antioxidative function, the corrosion resistance function and the function of electromagnetic interference prevention.

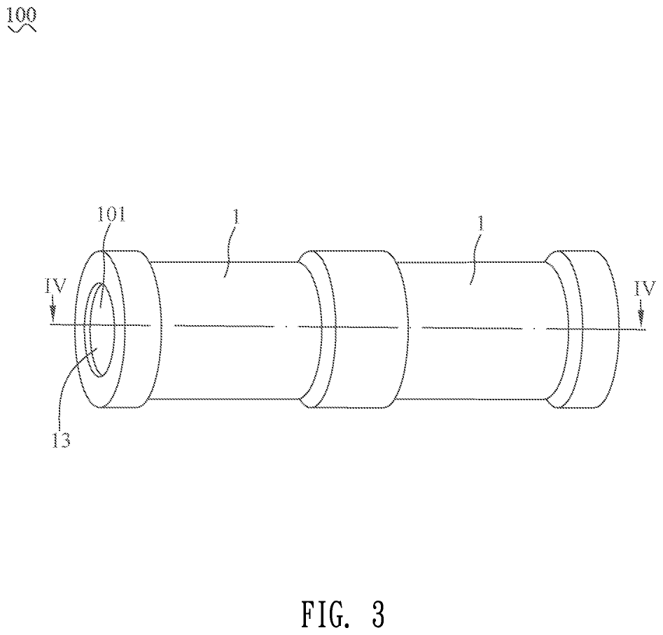

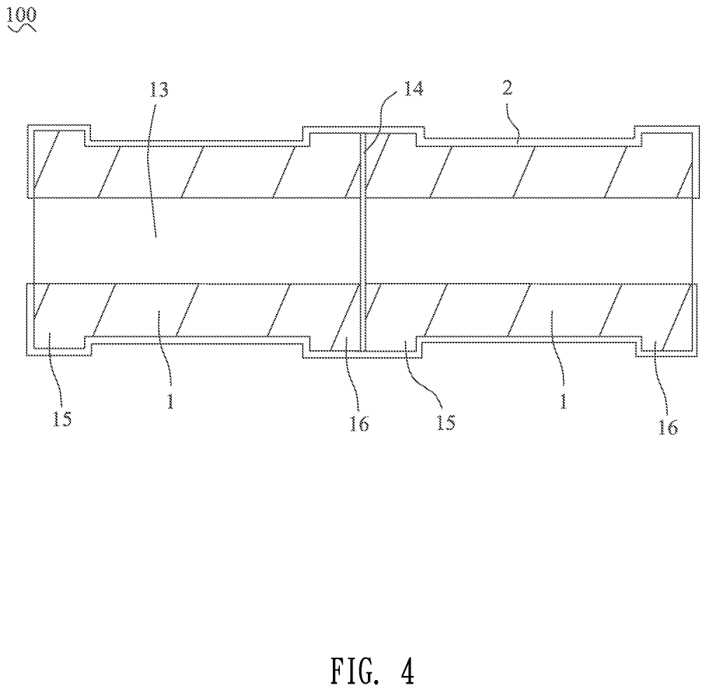

Referring to FIG. 3 and FIG. 4, the waveguide tube 1 and the waveguide tube assembly 100 in accordance with a second preferred embodiment of the present invention are shown. The waveguide tube assembly 100 includes at least two waveguide tubes 1 and the nano plating layer 2. Each waveguide tube 1 is cylindrical. Each waveguide tube 1 in accordance with the second preferred embodiment is a hollow metal tube and is shown as a hollow cylinder shape. A middle portion of each waveguide tube 1 is a hollow portion. The hollow portion of each waveguide tube 1 is defined as the waveguide space 13 longitudinally penetrating through two opposite end surfaces of each waveguide tube 1. The middle portion of each waveguide tube 1 has the waveguide space 13 longitudinally penetrating through a front end surface and a rear end surface of each waveguide tube 1. The at least two waveguide tubes 1 are longitudinally fastened with and connected with one another by an ultrasonic welding way, so the waveguide spaces 13 of the at least two waveguide tubes 1 are connected with one another to form a combined waveguide space 101. The combined waveguide space 101 is of a substantially cylinder shape. A connecting portion between each two waveguide tubes 1 will form the tiny interstice 14. In the second preferred embodiment, the front end surface and the rear end surface of each waveguide tube 1 are circular ring shapes. When the waveguide tube assembly 100 has two waveguide tubes 1, one waveguide tube 1 is longitudinally located behind and connected with the other waveguide tube 1, and a front end surface of the one waveguide tube 1 is connected with a rear end surface of the other waveguide tube 1. When each waveguide tube 1 proceeds with a signal transmission, a transmission signal will be dispersed from the tiny interstice 14. An attenuation of the transmission signal of each waveguide tube 1 is caused, and the dispersed transmission signal will interfere other elements (not shown).

Specifically, each waveguide tube 1 has a first connecting end 15 and a second connecting end 16 disposed at a front end and a rear end of each waveguide tube 1, respectively. When the at least two waveguide tubes 1 are longitudinally connected in sequence, the at least two waveguide tubes 1 are longitudinally arranged in sequence, the waveguide spaces 13 of the at least two waveguide tubes 1 are corresponding, and communicated with and connected with one another, each two adjacent waveguide tubes 1 are longitudinally connected with each other, the first connecting end 15 of one of the each two adjacent waveguide tubes 1 is connected with the second connecting end 16 of the other one of the each two adjacent waveguide tubes 1 which is located in front of the one of the each two adjacent waveguide tubes 1. A front end surface of the one of the each two adjacent waveguide tubes 1 is connected with a rear end surface of the other one of the each two adjacent waveguide tubes 1 which is located in front of the one of the each two adjacent waveguide tubes 1. The interstice 14 is generated and formed at a connecting portion where the first connecting end 15 and the second connecting end 16 of the each two adjacent waveguide tubes 1 are connected.

In the second preferred embodiment, the nano plating layer 2 is plated on an outer surface of the waveguide tube assembly 100. Specifically, the nano plating layer 2 is plated on outer surfaces of the at least two waveguide tubes 1 of the waveguide tube assembly 100 which are together connected and are plated by the nano-plating way, and the nano plating layer 2 fills up each interstice 14 formed among the at least two waveguide tubes 1 of the waveguide tube assembly 100.

In the second preferred embodiment, in a nano-plating process of the waveguide tube assembly 100, the electroplating liquid is prepared, and the nanoparticles are added into the electroplating liquid to form the nano electroplating liquid. When the waveguide tube assembly 100 is plated, the nanoparticles continuously rub against the outer surface of the nano plating layer 2 exposed outside, so that the bubbles of the outer surface of the nano plating layer 2 are effectively eliminated and the nano plating layer 2 is mechanically grinded and polished for improving the finish degree and the comprehensive mechanism strength of the nano plating layer 2. The nano plating layer 2 has the nanoparticles. The nano plating layer 2 is formed by a mixture of the nanometal material and a ceramic material. The ingredient of the nano plating layer 2 includes the nickel mineral salts, such as the nickel sulfate and the nickel chloride, the inorganic acid, such as the boric acid, the interfacial agent, such as the lauryl sodium sulfate, the nanoparticles and so on. Each nanoparticle is one of the silver nanoparticle, the titanium dioxide nanoparticle, the silicon dioxide nanoparticle, the alumina nanoparticle, the zinc oxide nanoparticle and others. The nano plating layer 2 including the nanoparticles provides the waterproof function, the antioxidative function, the sulfuration corrosion resistance function and the function of electromagnetic interference prevention for the waveguide tube 1 and the waveguide tube assembly 100. The above-mentioned ingredient of the nano plating layer 2 is just provided by the general ingredients and is without being limited to the ingredients which are disclosed above. In this way, the waveguide tube 1 and the waveguide tube assembly 100 are effectively capable of eliminating the signal losses generated by the interstice 14 and the electromagnetic interferences. In addition, the waveguide tube 1 and the waveguide tube assembly 100 have the multiple functions which include the waterproof function, the antioxidative function, the corrosion resistance function and the function of electromagnetic interference prevention.

Specifically, the nano plating layer 2 is plated on the outer surfaces of the at least two waveguide tubes 1 of the waveguide tube assembly 100 which are together connected by use of the nano electroplating liquid, and the nano plating layer 2 fills up each interstice 14 formed at the position where the first connecting end 15 and the second connecting end 16 of the each two adjacent waveguide tubes 1 of the waveguide tube assembly 100 are connected to make the position where the first connecting end 15 and the second connecting end 16 of the each two adjacent waveguide tubes 1 of the waveguide tube assembly 100 are together connected become seamless.

When the waveguide tube assembly 100 is manufactured, firstly, each waveguide tube 1 is connected with another waveguide tube 1, the each two adjacent waveguide tubes 1 of the waveguide tube assembly 100 are together connected by the ultrasonic welding way to weld the position where the first connecting end 15 and the second connecting end 16 of the each two adjacent waveguide tubes 1 of the waveguide tube assembly 100 are together connected. At the moment, a middle of the waveguide tube assembly 100 forms the combined waveguide space 101. Secondly, after two opposite ends of the combination space 101 of the waveguide tube assembly 100 are sealed up, the waveguide tube assembly 100 is proceeded with the nano-plating procedure, and the nanometal material is plated on the outer surface of the waveguide tube assembly 100 to form the nano plating layer 2, at the moment, the nano plating layer 2 fills up the interstices 14 formed at the connecting portions disposed among the at least two waveguide tubes 1 of the waveguide tube assembly 100 to make the connecting portions disposed among the at least two waveguide tubes 1 of the waveguide tube assembly 100 be seamless, so the waveguide tube assembly 100 is completed being manufactured.

In the present invention, each waveguide tube 1 is the hollow metal tube. The waveguide tube 1 in accordance with the first preferred embodiment has a square cross section or a rectangular cross section seen from a longitudinal view. The waveguide tube 1 in accordance with the second preferred embodiment has a cross section which is the circular ring shape and seen from the longitudinal view.

As described above, because the first waveguide block 11 is connected with the second waveguide block 12, the nano plating layer 2 fills up the interstice 14 generated between the first waveguide block 11 and the second waveguide block 12 of the waveguide tube 1 by virtue of the nano plating layer 2 being plated on the outer surface of the waveguide tube 1, and because the at least two waveguide tubes 1 of the waveguide tube assembly 100 are connected, the nano plating layer 2 fills up each interstice 14 formed at the position where the first connecting end 15 and the second connecting end 16 of the each two adjacent waveguide tubes 1 of the waveguide tube assembly 100 are connected by virtue of the nano plating layer 2 being plated on the outer surface of the waveguide tube assembly 100, so that the waveguide tube 1 and the waveguide tube assembly 100 are effectively capable of filling up the interstice 14 to reduce the signal losses generated by the interstice 14 and the electromagnetic interferences. In addition, the waveguide tube 1 and the waveguide tube assembly 100 have the multiple functions which include the waterproof function, the antioxidative function, the corrosion resistance function and the function of electromagnetic interference prevention.

What is claimed is:

1. A waveguide tube, comprising:
a first waveguide block having a first combination surface, a middle of one side of the first combination surface being recessed inward to form a first waveguide recess penetrating through two end surfaces of the first waveguide block;
a second waveguide block fastened with the first waveguide block, the second waveguide block having a second combination surface disposed corresponding to the first combination surface, a middle of one side of the second combination surface being recessed inward and opposite to the first waveguide recess to form a second waveguide recess penetrating through two end surfaces of the second waveguide block, the second waveguide recess being disposed corresponding to the first waveguide recess, the first combination surface of the first waveguide block and the second combination surface of the second waveguide block being attached with each other, so the first waveguide recess being combined with the second waveguide recess to form a waveguide space between the first waveguide block and the second waveguide block; and
a nano plating layer plated on outer surfaces of the first waveguide block and the second waveguide block which are completed being assembled and are plated by a nano-plating way, the nano plating layer filling up an interstice generated between the first waveguide block and the second waveguide block, the nano plating layer being formed by a nanometal material, the nano plating layer having nanoparticles.

2. The waveguide tube as claimed in claim 1, wherein an ingredient of the nano plating layer includes nickel mineral salts, an inorganic acid and an interfacial agent.

3. The waveguide tube as claimed in claim 1, wherein the first waveguide block and the second waveguide block are rectangular shapes.

4. The waveguide tube as claimed in claim 1, wherein the waveguide tube has a square cross section seen from a longitudinal view.

5. The waveguide tube as claimed in claim 1, wherein the waveguide tube has a rectangular cross section seen from a longitudinal view.

6. The waveguide tube as claimed in claim 1, wherein the waveguide space is cylindrical.

7. The waveguide tube as claimed in claim 1, wherein the first combination surface and the second combination surface are welded with each other by an ultrasonic welding way.

8. A waveguide tube assembly, comprising:
at least two waveguide tubes, each waveguide tube being a hollow metal tube, a hollow portion of each waveguide tube being a waveguide space longitudinally penetrating through two opposite end surfaces of each waveguide tube, the waveguide space being used for transmitting high-frequency electromagnetic waves, the at least two waveguide tubes being longitudinally fastened with and connected with one another, so the waveguide spaces of the at least two waveguide tubes being connected with one another to form a combined waveguide space; and
a nano plating layer plated on outer surfaces of the at least two waveguide tubes which are together connected and are plated by a nano-plating way, and the nano plating layer filling up each interstice formed among the at least two waveguide tubes, the nano plating layer being formed by a nanometal material, the nano plating layer having nanoparticles.

9. The waveguide tube assembly as claimed in claim 8, wherein each waveguide tube has a first connecting end and a second connecting end disposed at a front end and a rear end of each waveguide tube, respectively, when the at least two waveguide tubes are longitudinally connected in sequence, the at least two waveguide tubes are longitudinally arranged in sequence, each two adjacent waveguide tubes are longitudinally connected with each other, the first connecting end of one of the each two adjacent waveguide tubes is connected with the second connecting end of the other one of the each two adjacent waveguide tubes which is located in front of the one of the each two adjacent waveguide tubes, the waveguide spaces of the at least two waveguide tubes are corresponding, and communicated with and connected with one another.

10. The waveguide tube assembly as claimed in claim 9, wherein the interstice is generated and formed at a connecting portion where the first connecting end and the second connecting end of the each two adjacent waveguide tubes are connected.

11. The waveguide tube assembly as claimed in claim 8, wherein a front end surface of one of each two adjacent waveguide tubes is connected with a rear end surface of the other one of the each two adjacent waveguide tubes which is located in front of the one of the each two adjacent waveguide tubes.

12. The waveguide tube assembly as claimed in claim 11, wherein the front end surface and the rear end surface of each waveguide tube are circular ring shapes.

13. The waveguide tube assembly as claimed in claim 8, wherein each waveguide tube is shown as a hollow cylinder shape.

14. The waveguide tube assembly as claimed in claim 8, wherein the waveguide space is cylindrical.

15. The waveguide tube assembly as claimed in claim 8, wherein the nano plating layer is formed by a mixture of the nanometal material and a ceramic material.

16. The waveguide tube assembly as claimed in claim 8, wherein the at least two waveguide tubes are longitudinally fastened with and connected with one another by an ultrasonic welding way.

17. A waveguide tube assembly, comprising:
at least two waveguide tubes of which each is a hollow metal tube and is shown as a hollow cylinder shape, a middle portion of each waveguide tube having a waveguide space longitudinally penetrating through a front end surface and a rear end surface of each waveguide tube, the waveguide space being cylindrical, the at least two waveguide tubes being longitudinally fastened with and connected with one another by an ultrasonic welding way, the front end surface of one of each two adjacent waveguide tubes being connected with a rear end surface of the other one of the each two adjacent waveguide tubes which is located in front of the one of the each two adjacent waveguide tubes, so the waveguide spaces of the at least two waveguide tubes being connected with one another to form a combined waveguide space; and
a nano plating layer plated on outer surfaces of the at least two waveguide tubes which are together connected and are plated by a nano-plating way, and the nano plating layer filling up interstices formed at connecting portions disposed among the at least two waveguide tubes to make the connecting portions disposed among the at least two waveguide tubes be seamless, the nano plating layer being formed by a nanometal material, the nano plating layer having nanoparticles.

18. The waveguide tube assembly as claimed in claim 17, wherein the nano plating layer is formed by a mixture of the nanometal material and a ceramic material.
